(19) United States
(12) Patent Application Publication
(10) Pub. No.: US 2019/0375290 A1
(43) Pub. Date: Dec. 12, 2019

(54) FILLER TUBE AND FILLER NECK HAVING THE SAME

(71) Applicant: KOREA FUEL-TECH CORPORATION, Anseong (KR)

(72) Inventors: Ki Hong KIM, Anseong (KR); Dong Chul LEE, Hwaseong (KR)

(21) Appl. No.: 16/426,992

(22) Filed: May 30, 2019

(30) Foreign Application Priority Data
Jun. 12, 2018 (KR) 10-2018-0067179

(51) Int. Cl. B60K 15/04

(52) U.S. Cl. CPC B60K 15/0406; B60K 2015/0461; B60K 2015/0429

(57) ABSTRACT

Provided are a filler tube and a filler neck including the filler tube that may reliably prevent false injection of fuel even though structures thereof for suppressing the false injection of the fuel are simplified. A filler tube defining a path through which fuel from an injection nozzle is supplied to a fuel tank is provided. The filler tube includes: a main body having a hollow defined therein, into which the injection nozzle is inserted; a first rotating part disposed to penetrate one side wall of the main body and axially connected to the main body to be axially rotatable outwardly of the main body; and a second rotating part disposed to penetrate the other side wall of the main body to face away from the first rotating part and axially connected to the main body to be axially rotatable outwardly of the main body.

### CROSS-REFERENCE TO RELATED APPLICATIONS

Priority to Korean patent application number 10-2018-0067179 filed on Jun. 12, 2018 the entire disclosure of which is incorporated by reference herein, is claimed.

### BACKGROUND OF THE INVENTION

### Field of the invention

The present disclosure relates to a filler tube and a filler neck including the filler tube, and more particularly, relates to a filler tube for guiding fuel introduced from a fuel injection nozzle to a fuel tank and a filler neck including the filler tube.

### Related Art

Generally, a vehicle may obtain power to travel by various fuels such as gasoline, diesel, LPG (Liquefied Petroleum Gas), LNG (Liquefied Natural Gas), CNG (Compressed Natural Gas), and the like. These various fuels of the vehicle are transferred through a fuel injection tube, referred to as a filler neck, to a fuel tank of the vehicle and stored inside the fuel tank.

The filler neck forms a filler tube that defines an insertion path of the fuel injection nozzle. In addition, the filler tube has a different structure depending on a type of the fuel supplied to the fuel tank. The prior art for such a filler neck has already been published in “Korean Patent No. 1390964 (FILLER TUBE ASSEMBLY AND FILLER NECK HAVING THE SAME, Apr. 24, 2014)”.

As in the above patent, a conventional filler tube controls entry and exit of a fuel injection nozzle based on an inner diameter difference between the filler tube and the fuel injection nozzle, thereby suppressing false injection of the fuel. However, the conventional filler tube has a complicated structure for suppressing the false injection of the fuel, therefore a production efficiency of the filler tube is low and production cost is increased.

### PRIOR ART DOCUMENT

### Patent Document

(Patent Document 1) Korean Patent No. 1390964 (FILLER TUBE ASSEMBLY AND FILLER NECK HAVING THE SAME, Apr. 24, 2014)

### SUMMARY OF THE INVENTION

The present disclosure provides a filler tube and a filler neck including the filler tube that may reliably prevent false injection of fuel even though structures thereof for suppressing the false injection of the fuel are simplified.

In an aspect, a filler tube defining a path through which fuel from an injection nozzle is supplied to a fuel tank is provided. The filler tube includes: a main body having a hollow defined therein, into which the injection nozzle is inserted; a first rotating part disposed to penetrate one side wall of the main body and axially connected to the main body to be axially rotatable outwardly of the main body; and a second rotating part disposed to penetrate the other side wall of the main body to face away from the first rotating part and axially connected to the main body to be axially rotatable outwardly of the main body. The first and second rotating parts are respectively rotated outwardly of the main body to open an entry path of the injection nozzle when the injection nozzle is inserted into the hollow and presses one face of each of the first and second rotating parts.

In one embodiment, one face of each of the first and second rotating parts pressed by the injection nozzle may be downwardly inclined.

In one embodiment, the filler tube may further include a door disposed below the first and second rotating parts and axially rotated in an entry direction of the injection nozzle to open the hollow.

In one embodiment, the door may be rotatable in the entry direction of the injection nozzle when the first and second rotating parts are pressed by the injection nozzle and are rotated. In addition, the door may be locked by the first and second rotation parts such that the rotation of the door may be restricted when the first and second rotating parts are not pressed by the injection nozzle.

In one embodiment, a supporting groove may be defined in each of the inclined faces of the first and second rotating parts, and a supporting projection extending from the door and insertable into the supporting groove may be formed on the door.

In one embodiment, the supporting projection may extend outwardly of the main body in an upwardly inclined manner to be inserted into the supporting groove.

In one embodiment, the first and second rotating parts may not be rotated when the injection nozzle having a diameter smaller than an area between the first and second rotating parts is inserted. In addition, the first and second rotating parts may be rotated outwardly when the injection nozzle having a diameter larger than the area between the first and second rotating parts is inserted.

In an aspect, a filler neck defining a path through which fuel from an injection nozzle is supplied to a fuel tank is provided. The filler neck includes: a filler tube defining a path through which the injection nozzle is inserted; and a filler pipe for connecting the filler tube and the fuel tank. Further, the filler tube includes: a main body having a hollow defined therein, into which the injection nozzle is inserted; a first rotating part disposed to penetrate one side wall of the main body and axially connected to the main body to be axially rotatable outwardly of the main body; and a second rotating part disposed to penetrate the other side wall of the main body to face away from the first rotating part and axially connected to the main body to be axially rotatable outwardly of the main body, wherein the first and second rotating parts are respectively rotated outwardly of the main body to open an entry path of the injection nozzle when the injection nozzle is inserted into the hollow and presses one face of each of the first and second rotating parts.

In one embodiment, one face of each of the first and second rotating parts pressed by the injection nozzle may be downwardly inclined.

In one embodiment, the filler neck may further include a door disposed below the first and second rotating parts and axially rotated in an entry direction of the injection nozzle to open the hollow.

In one embodiment, the door may be rotatable in the entry direction of the injection nozzle when the first and second rotating parts are pressed by the injection nozzle and rotated. In addition, the door may be locked by the first and second rotation parts such that the rotation thereof is restricted when the first and second rotating parts are not pressed by the injection nozzle.

In one embodiment, a supporting groove may be defined in each of the inclined faces of the first and second rotating parts, and a supporting projection extending from the door and insertable into the supporting groove may be formed on the door.

In one embodiment, the supporting projection may extend outwardly of the main body in an upwardly manner to be inserted into the supporting groove.

In one embodiment, the first and second rotating parts may not be rotated when an injection nozzle having a diameter smaller than an area between the first and second rotating parts is inserted. In addition, the first and second rotating parts may be rotated outwardly when an injection nozzle having a diameter larger than the area between the first and second rotating parts is inserted.

### BRIEF DESCRIPTION OF THE DRAWINGS

FIG. 1 is a perspective view schematically illustrating a filler neck according to the present embodiment;

FIG. 2 is a cross-sectional view schematically illustrating a filler neck according to the present embodiment;

FIG. 3 is a perspective view schematically illustrating an opening and closing assembly according to the present embodiment;

FIG. 4 is a cross-sectional view schematically illustrating an opening and closing assembly according to the present embodiment

FIG. 5 is an exploded view schematically illustrating an opening and closing assembly according to the present embodiment;

FIG. 6 illustrates that an opening and closing assembly according to the present embodiment remains closed as a first fuel injection nozzle is inserted; and

FIG. 7 is an operation diagram illustrating that an opening and closing assembly according to the present embodiment is opened as a second fuel injection nozzle is inserted.

### DESCRIPTION OF EXEMPLARY EMBODIMENTS

Hereinafter, embodiments of the present disclosure will be described in detail with reference to the accompanying drawings. However, the present disclosure is not limited to the embodiments disclosed below, but may be implemented in various forms. The embodiments of the present disclosure are provided to make the disclosure of the present disclosure complete and fully inform those skilled in the art to which the present disclosure pertains of the scope of the present disclosure. The drawings may be exaggerated to illustrate the present disclosure in detail, wherein like reference numerals refer to like elements throughout the drawings.

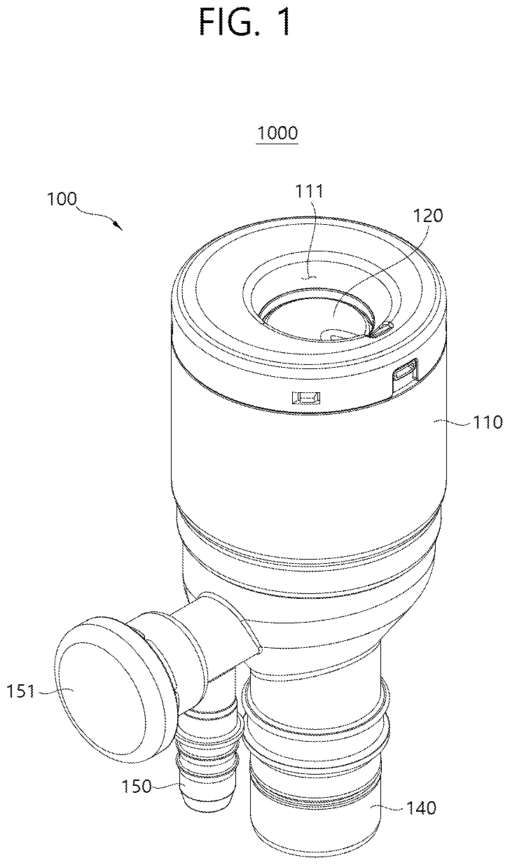

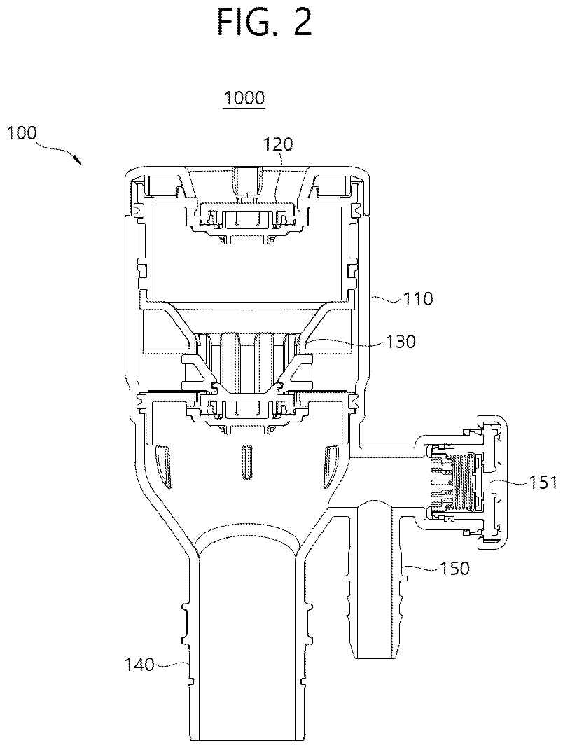

FIG. 1 is a perspective view schematically illustrating a filler neck according to the present embodiment. In addition, FIG. 2 is a cross-sectional view schematically illustrating a filler neck according to the present embodiment.

As shown in FIGS. 1 and 2, a filler neck 1000 according to the present embodiment may be provided in a capless structure and includes a filler tube 100.

The filler tube 100 defines a path through which fuel injection nozzles 11 and 12 are inserted, and fuels from the fuel injection nozzles 11 and 12 are supplied to a fuel tank. In this connection, the filler tube 100 opens and closes the fuel supply path based on a diameter of the fuel injection nozzle 11 or 12, thereby preventing false injection of the fuel.

The filler tube 100 may include a housing 110, an upper door 120, an opening and closing assembly 130, a fuel pipe connection 140, and a gas pipe connection 150.

First, the housing 110 forms an outer surface of the filler tube 100. A gate 111 through which the fuel injection nozzles 11 and 12 enter is formed at a top of the housing 110. In this connection, the housing 110 is provided in a substantially cylindrical shape, and a hollow is defined in a fuel injection direction.

Further, the upper door 120 is disposed adjacent to the gate 111 such that the gate 111 may be opened or closed depending on whether the fuel injection nozzle 11 or 12 enters. In this connection, the upper door 120 may be supported inside the housing 110 and may include an elastic member such as a spring.

This upper door 120 maintains a closed state of the gate 111 usually. However, when the fuel injection nozzle 11 or 12 is inserted into the gate 111, the upper door 120 axially rotates in a direction of insertion of the fuel injection nozzle 11 or 12 to open the gate 111. Further, when the fuel injection nozzle 11 or 12 is separated from the gate 111, the upper door 120 axially rotates in a separating direction of the fuel injection nozzles 11 and 12 to close the gate 111.

Further, the opening and closing assembly 130 is supported within the housing 110. In this connection, the opening and closing assembly 130 may be disposed below the upper door 120 and may be integrally or independently provided with the upper door 120. Further, an O-ring may be disposed between the housing 110 and the opening and closing assembly 130. The O-ring may include a plurality of O-rings to prevent a movement of the opening and closing assembly 130 and to seal between the housing 110 and the opening and closing assembly 130.

In this connection, the opening and closing assembly 130 allows the fuel supply path to be opened or closed depending on a type of the fuel injection nozzles 11 and 12. The opening and closing assembly 130 will be described again with reference to the accompanying drawings.

The fuel pipe connection portion 140 is formed at a lower portion of the housing 110. The fuel pipe connection 140 may be provided in a cylindrical shape and may have a diameter smaller than a diameter of the housing 110. The fuel pipe connection portion 140 is connected to the fuel tank via a fuel pipe such that the fuel from the injection nozzle 11 or 12 may be supplied to the fuel tank.

Further, the gas pipe connection 150 to which a gas pipe may be connected is disposed on an outer wall of the housing 110. In this connection, the gas pipe connection 150 may be provided with a pressure valve 151. The gas pipe connection 150 connects the gas pipe and inside of the housing 110 to define a gas flow path.

Hereinafter, the opening and closing assembly 130 will be described in detail with reference to the accompanying drawings. However, the above-described components will not be described in detail and will be described by denoting the same reference numerals.

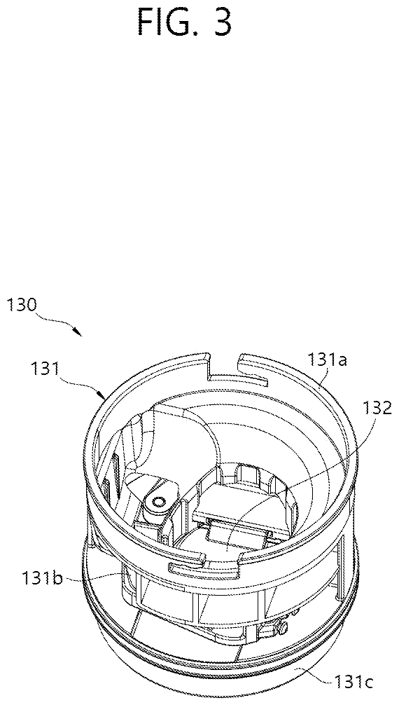

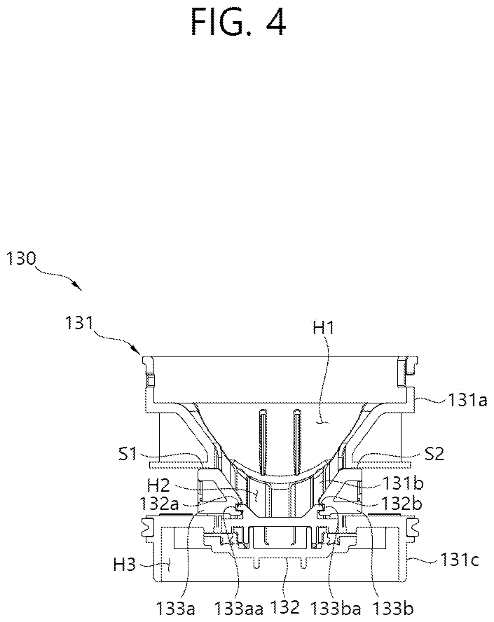

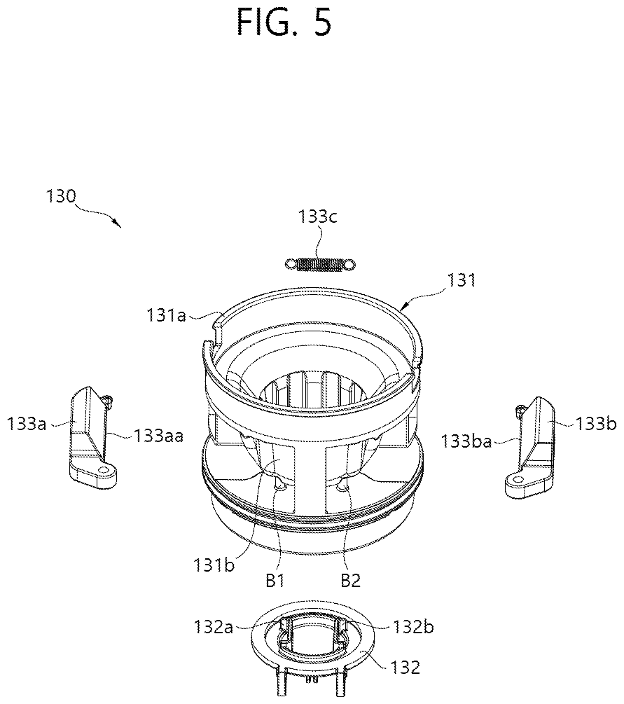

FIG. 3 is a perspective view schematically illustrating an opening and closing assembly according to the present embodiment. FIG. 4 is a cross-sectional view schematically illustrating an opening and closing assembly according to the present embodiment. FIG. 5 is an exploded view schematically illustrating an opening and closing assembly according to the present embodiment.

As shown in FIGS. 3 to 5, the opening and closing assembly 130 according to the present embodiment includes an opening and closing main body 131.

The opening and closing main body 131 forms an outer surface of the opening and closing assembly 130. The opening and closing main body 131 may include an upper body 131a, a connecting body 131b, and a lower body 131c, which may be integrally formed with each other.

First, the upper body 131a is provided in a cylindrical shape and a first hollow H1 is defined therein to extend vertically. Further, an inner wall of the upper body 131a is provided such that a lower portion thereof is extended downwardly and inclined inwardly of a bottom opening. Thus, the lower hollow of the upper body 131a has a smaller diameter than a top opening.

Further, the connecting body 131b is connected to a bottom face of the upper body 131a. The connecting body 131b is provided in a cylindrical shape and may have an outer diameter smaller than an outer diameter of the upper body 131a. A second hollow H2 communicating with the first hollow H1 of the upper body 131a is defined in the connecting body 131b. In this connection, top and bottom openings of the connecting body 131b may have the same diameter as the bottom opening of the upper body 131a, but are not limited thereto.

Further, the lower body 131c is connected to a bottom face of the connecting body 131b. The lower body 131c is provided in a cylindrical shape and may have an outer diameter larger than the outer diameter of the connecting body 131b. Further, a third hollow H3 communicating with the second hollo H2 of the connecting body 131b is defined in the lower body 131c. In this connection, an opening of the lower body 131c may have the same diameter as the bottom opening of the connecting body 131b.

A plurality of gas exhaust grooves are defined in a portion of the inner wall of the opening and closing main body 131 in the fuel injection direction. The gas exhaust groove allows the gas inside the opening and closing main body 131 to be discharged to the outside even when the fuel injection nozzle 11 or 12 is inserted into the opening and closing main body 131.

Further, a door 132 and an extension member 133 may be mounted at the opening and closing main body 131.

First, the door 132 is disposed inside the lower body 131c and preferably below the opening of the lower body 131c. In this connection, the door 132 may be provided in a circular shape and may have a larger diameter than that of the opening of the lower body 131c. However, an upper region of the door 132 may be provided to be insertable into the opening of the lower body 131c, and the upper region of the door 132 may seal the opening when the door 132 closes the opening of the lower body 131c.

The door 132 may be supported by the lower body 131c and may include an elastic member such as a spring. Accordingly, the door 132 maintains a closed state of the opening of the lower body 131c usually.

However, when the fuel injection nozzle 11 or 12 is inserted into the lower body 131c, the door 132 may axially rotate in the insertion direction of the fuel injection nozzle 11 or 12 to open the opening of the lower body 131c. In addition, when the fuel injection nozzle 11 or 12 is separated from the lower body 131c, the door 132 may axially rotate in the separating direction of the fuel injection nozzle 11 or 12 based on a restoring force of the elastic member to close the opening of the lower body 131c.

The extension member 133 is connected to the door 132 to limit the rotation of the door 132.

First, the extension member 133 allows the door 132 to be opened when the fuel injection nozzle 11 or 12 having a predetermined diameter is inserted into the opening and closing main body 131. In addition, when the fuel injection nozzle 11 or 12 having a diameter smaller than the predetermined diameter is inserted into the opening and closing main body 131, the extension member 133 disallows the door 132 to be opened.

The extension member 133 may include a first rotation part 133a, a second rotation part 133b, and an elastic part 133c.

First, the first rotating part 133a may be provided as a frame having a long length in a plane direction of the opening and closing main body 131. In this connection, one end of the first rotating part 133a is axially connected to a first supporting protrusion B1 formed on a top face of the lower body 131c. Thus, the first rotating part 133a becomes axially rotatable about the first supporting protrusion B1.

At least a portion of the first rotating part 133a may be inserted into the opening and closing main body 131 through a first slit S1 defined in one side wall of the connecting body 131b. In this connection, one face of the first rotating part 133a that may be inserted into the opening and closing main body 131 to face the fuel injection nozzle 11 or 12 is provided to have an inclined face. In this connection, the inclined face is extended downwardly and inclined inwardly of the second hollow H2.

Further, the second rotating part 133b may be provided as a frame having a long length in the opening and closing main body 131. In this connection, one end of the second rotating part 133b is axially connected to a second supporting protrusion B2 formed on the top face of the lower body. Thus, the second rotating part 133b becomes axially rotatable about the second supporting protrusion B2.

At least a portion of the second rotating part 133b may be inserted into the opening and closing main body 131 through a second slit S2 defined in the other side wall of the connecting body 131b. In this connection, one face of the second rotating part 133b that may be inserted into the opening and closing main body 131 to face the fuel injection nozzle 11 or 12 is provided to have an inclined face. In this connection, the inclined face is extended downwardly and inclined inwardly of the second hollow H2.

In addition, the elastic part 133c allows the other ends of the first and second rotating parts 133a and 133b to be connected to each other. In this connection, the elastic part 133c is provided as a spring having a predetermined length. Accordingly, the first and second rotating parts 133a and 133b may maintain a distance mutually predetermined by the elastic part 133c, and at least a portion of the first and second rotating parts 133a and 133b may be kept being inserted in the opening and closing main body 131.

Further, each of the first and second rotating parts 133a and 133b is provided with a supporting groove for restricting the door 132.

First, a first supporting groove 133aa is defined in a lower portion of the inclined face of the first rotating part 133a in a longitudinal direction. In addition, a second supporting groove 133ba is defined in a lower portion of the inclined face of the second rotating part 133b in the longitudinal direction. In this connection, supporting projections extending from a top face of the door 132 are respectively inserted into the first and second supporting grooves 133aa and 133ba.

More specifically, first and second supporting projections 132a and 132b are disposed on the top face of the door 132. The first supporting projection 132a extends outwardly in an upwardly manner to be inserted into the first supporting groove 133aa. In addition, the second supporting projection 132b extends outwardly in an upwardly manner to be inserted into the second supporting groove 133ba.

Accordingly, the door 132 usually maintains a state of being locked by the first and second rotating parts 133a and 133b. Therefore, when the door 132 remains to be locked, the door 132 is restricted from axially rotating in the fuel supply direction. However, when the first and second rotating parts 133a and 133b are respectively rotated outwardly of the opening and closing main body 131, the door 132 becomes axially rotatable as the first and second supporting projections 132a and 132b are respectively separated from the first and second supporting grooves 133aa and 133ba.

Accordingly, the opening and closing assembly 130 may change the locked state of the door 132, depending on the type of the fuel injection nozzles 11 and 12, to allow the fuel injection nozzle 11 or 12 to pass through the door 132 or to block the fuel injection nozzle 11 or 12 by the door 132.

Further, the opening and closing assembly 130 achieves internal sealing of the filler neck 1000 based on systematic operations of the door 132 and the extension member 133 even though the filler neck 1000 has the capless structure. Thus, a separate cap for sealing may not be needed.

Hereinafter, the operations of the opening and closing assembly 130 based on the insertion of the first fuel injection nozzle 11 and the second fuel injection nozzle 12 will be described in detail with reference to the accompanying drawings. Hereinafter, an embodiment in which the filler neck 1000 according to the present embodiment is mounted on a diesel vehicle will be described. However, this is to illustrate the present embodiment and is not limited to the diesel vehicle.

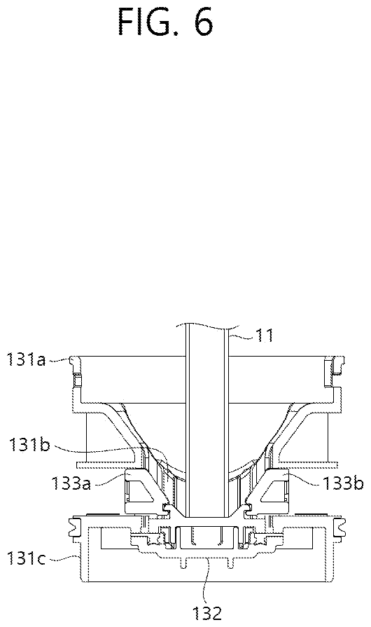

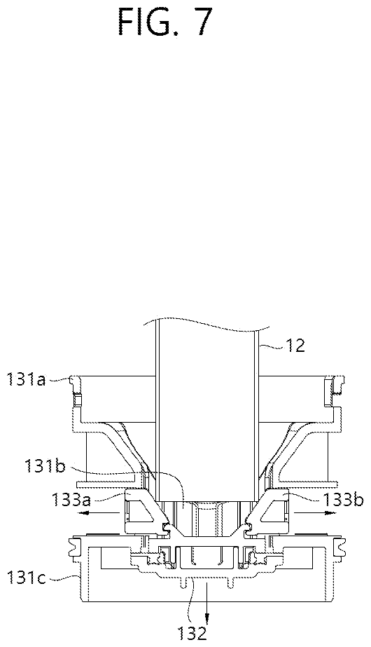

FIG. 6 illustrates that an opening and closing assembly according to the present embodiment remains closed as a first fuel injection nozzle is inserted. FIG. 7 is an operation diagram illustrating that an opening and closing assembly according to the present embodiment is opened as a second fuel injection nozzle is inserted.

As shown in FIGS. 6 and 7, the filler neck 1000 according to the present embodiment may be mounted on the diesel vehicle.

In this connection, the filler neck 1000 maintains the closed state of the door 132 when the first fuel injection nozzle 11 for supplying gasoline is inserted. In addition, when the second fuel injection nozzle 12 for supplying diesel is inserted, the filler neck 1000 may open the door 132 such that the diesel fuel may be supplied to the fuel tank.

Hereinafter, the insertion of the first fuel injection nozzle 11 and the insertion of the second fuel injection nozzle 12 will be distinguished from each other and described.

First, as shown in FIG. 6, the first fuel injection nozzle 11 may be inserted into the filler neck 1000. In this connection, the opening and closing assembly 130 maintains the door 132 closed to prevent the supply of the gasoline to the diesel vehicle.

More specifically, the first and second rotating parts 133a and 133b, which are partly inserted into the opening and closing main body 131, have a space therebetween having a diameter larger than the outer diameter of the first fuel injection nozzle 11. Thus, the first fuel injection nozzle 11 enters the space between the first and second rotating parts 133a and 133b when entering the opening and closing main body 131. Therefore, the first fuel injection nozzle 11 is prevented from entering by the door 132 whose rotation is limited by the extension member 133.

In this connection, even though the first fuel injection nozzle 11 presses one of the first and second rotating parts 133a and 133b along an inserting direction of the first fuel injection nozzle 11, the door 132 will not be opened when the supporting projection of the door 132 remains inserted into the supporting groove.

However, as shown in FIG. 7, the second fuel injection nozzle 12 having a larger diameter than the first fuel injection nozzle may be inserted into the filler neck 1000. In this connection, the opening and closing assembly 130 unlocks the door 132 to allow the second fuel injection nozzle 12 to downwardly move into the lower body 131c.

More specifically, as the second fuel injection nozzle 12 is inserted into the opening and closing main body 131, the second fuel injection nozzle 12 comes into contact with one face of each of the first and second rotating parts 133a and 133b. In this connection, the second fuel injection nozzle 12 enters the space between the first and second rotating parts 133a and 133b due to forces of the inclined faces of the first and second rotating parts 133a and 133b and the second fuel injection nozzle 12 for entering the opening and closing main body 131. At the same time, the first and second rotating parts 133a and 133b are axially rotated outwardly due to the entering of the second fuel injection nozzle 12, respectively.

Accordingly, as the first and second rotating parts 133a and 133b axially rotate, the supporting projection of the door 132 is separated from the supporting groove. Accordingly, the door 132 is unlocked from the first and second rotating parts 133a and 133b. Consequently, the second fuel injection nozzle 12 axially rotates the unlocked door 132 and downwardly moves into the lower body 131c.

Thereafter, the second fuel injection nozzle 12 supplies the diesel fuel and is separated from the filler neck 1000.

At this time, as the second fuel injection nozzle 12 is separated from the lower body 131c, the opened door 132 closes the opening of the lower body 131c by the elastic member. In addition, when the second fuel injection nozzle 12 is separated from the lower body 131c, the first and second rotating parts 133a and 133b are returned to initial positions thereof by the elastic part 133c. That is, portions of the first and second rotating parts 133a and 133b are inserted into the opening and closing main body 131. Accordingly, the first and second supporting projections 132a and 132b of the door 132 may be inserted into the first and second supporting grooves 133aa and 133ba, respectively, and the door 132 may be locked again by the first and second rotating parts 133a and 133b.

As such, the filler tube and the filler neck including the filler tube prevent the false injection of the fuel, thereby preventing vehicle failure and financial loss caused by injecting the false injection of the fuel.

Further, structures of the filler tube and the filler neck including the filler tube according to the present disclosure are simplified, thereby improving the productivity of the filler tube.

The filler tube and the filler neck including the filler tube according to the present disclosure achieve the internal sealing while having the capless structure.

The technical effects of the present disclosure as described above are not limited to the effects mentioned above, and other technical effects not mentioned may be clearly understood by those skilled in the art from the above description.

The embodiment of the present disclosure described above and shown in the drawings should not be construed as limiting the technical idea of the present disclosure. The scope of the present disclosure is limited only by the appended claims. Those skilled in the art to which the present disclosure pertains may variously modify and alter the technical idea of the present disclosure. Accordingly, such modification and alteration will fall within the scope of the present disclosure so long as they are apparent to those skilled in the art.

What is claimed is:

1. A filler tube defining a path through which fuel from an injection nozzle is supplied to a fuel tank, the filler tube comprising:
a main body having a hollow defined therein, into which the injection nozzle is inserted;
a first rotating part disposed to penetrate one side wall of the main body and axially connected to the main body to be axially rotatable outwardly of the main body; and
a second rotating part disposed to penetrate the other side wall of the main body to face away from the first rotating part and axially connected to the main body to be axially rotatable outwardly of the main body,
wherein the first and second rotating parts are respectively rotated outwardly of the main body to open an entry path of the injection nozzle when the injection nozzle is inserted into the hollow and presses one face of each of the first and second rotating parts.

2. The filler tube of claim 1, wherein one face of each of the first and second rotating parts pressed by the injection nozzle is downwardly inclined.

3. The filler tube of claim 2, further comprising a door disposed below the first and second rotating parts and axially rotated in an entry direction of the injection nozzle to open the hollow.

4. The filler tube of claim 3, wherein the door is rotatable in the entry direction of the injection nozzle when the first and second rotating parts are pressed by the injection nozzle and are rotated, and
wherein the door is locked by the first and second rotation parts such that the rotation of the door is restricted when the first and second rotating parts are not pressed by the injection nozzle.

5. The filler tube of claim 4, wherein a supporting groove is defined in each of the inclined faces of the first and second rotating parts, and
wherein a supporting projection extending from the door and insertable into the supporting groove is formed on the door.

6. The filler tube of claim 5, wherein the supporting projection extends outwardly of the main body in an upwardly inclined manner to be inserted into the supporting groove.

7. The filler tube of claim 1, wherein the first and second rotating parts are not rotated when the injection nozzle having a diameter smaller than an area between the first and second rotating parts is inserted, and
wherein the first and second rotating parts are rotated outwardly when the injection nozzle having a diameter larger than the area between the first and second rotating parts is inserted.

8. A filler neck defining a path through which fuel from an injection nozzle is supplied to a fuel tank, the filler neck comprising:
a filler tube defining a path through which the injection nozzle is inserted; and
a filler pipe for connecting the filler tube and the fuel tank,
wherein the filler tube includes:
a main body having a hollow defined therein, into which the injection nozzle is inserted;
a first rotating part disposed to penetrate one side wall of the main body and axially connected to the main body to be axially rotatable outwardly of the main body; and
a second rotating part disposed to penetrate the other side wall of the main body to face away from the first rotating part and axially connected to the main body to be axially rotatable outwardly of the main body,
wherein the first and second rotating parts are respectively rotated outwardly of the main body to open an entry path of the injection nozzle when the injection nozzle is inserted into the hollow and presses one face of each of the first and second rotating parts.

9. The filler neck of claim 8, wherein one face of each of the first and second rotating parts pressed by the injection nozzle is downwardly inclined.

10. The filler neck of claim 9, further comprising a door disposed below the first and second rotating parts and axially rotated in an entry direction of the injection nozzle to open the hollow.

11. The filler neck of claim 10, wherein the door is rotatable in the entry direction of the injection nozzle when the first and second rotating parts are pressed by the injection nozzle and rotated, and
wherein the door is locked by the first and second rotation parts such that the rotation thereof is restricted when the first and second rotating parts are not pressed by the injection nozzle.

12. The filler neck of claim 11, wherein a supporting groove is defined in each of the inclined faces of the first and second rotating parts, and
wherein a supporting projection extending from the door and insertable into the supporting groove is formed on the door.

13. The filler neck of claim 12, wherein the supporting projection extends outwardly of the main body in an upwardly manner to be inserted into the supporting groove.

14. The filler neck of claim 8, wherein the first and second rotating parts are not rotated when an injection nozzle having a diameter smaller than an area between the first and second rotating parts is inserted, and
wherein the first and second rotating parts are rotated outwardly when an injection nozzle having a diameter larger than the area between the first and second rotating parts is inserted.
